(19) United States
(12) Patent Application Publication
(10) Pub. No.: US 2013/0076626 A1
(43) Pub. Date: Mar. 28, 2013

(54) THERAPEUTIC HUMAN INTERFACE DEVICE

(71) Applicant: Robert BANIK, Long Valley, NJ (US)

(72) Inventor: Robert BANIK, Long Valley, NJ (US)

(21) Appl. No.: 13/247,877

(22) Filed: Sep. 28, 2011

(51) Int. Cl. G06F 3/033

(52) U.S. Cl. 345/163

(57) ABSTRACT

A therapeutic human interface device includes an input device subassembly to detect movement of the device. A movable section is disposed on the device that allows for adjustment of a dimensional quality of the device. A drive system assembly may be in communication with a controller and cause the movable section to move.

### BACKGROUND OF THE INVENTION

The present invention generally relates to apparatus and methods for providing a human interface device for a computing device, and more specifically to a human interface device that changes shape or size to reduce or eliminate repetitive motion injuries.

Some human interface devices (e.g., a computer mouse) allow a user to manually configure aspects of the human interface device in a static fashion. Other human interface devices have sections or attachments that may be assembled to a shell or chassis to modify the shape or size of the human interface device. Other human interface devices provide customizable human interface devices, but still compel a user to continuously use a same action over a same range of motion.

As can be seen, there is a need for an improved apparatus and method that automatically changes shape during use to prevent repetitive stress disorders.

### SUMMARY OF THE INVENTION

In one aspect of the present invention, a therapeutic human interface device comprises an input device subassembly for detecting a movement of the therapeutic human interface device; a movable section disposed on the therapeutic human interface device, wherein the movable section is configured to move to alter a dimensional quality of the therapeutic human interface device; a drive system subassembly for causing the movable section to move; and a controller in communication with the drive system subassembly and the input device subassembly.

In another aspect of the present invention, a pointing device for detecting two-dimensional motion relative to a surface comprising a circuit board; a movable side wall having a first surface disposed on an outside surface of the pointing device; a movable top wall having a second surface disposed on the outside surface of the pointing device; a first means for urging the movable side wall in a first direction, wherein the first means for urging is controlled by the circuit board; and a second means for urging the movable top wall in a second direction, wherein the second means for urging is controlled by the circuit board.

In yet another aspect of the present invention, a method of controlling a dimensional quality of a human interface device comprises determining that the human interface device is engaged by a user; setting a countdown timer; setting a total time counter; incrementing the total time counter; determining that the human interface device is not engaged by the user; determining that the total time counter is not less than or equal to the countdown timer; and activating a drive subassembly associated to the countdown timer, wherein the drive subassembly alters the dimensional quality of the human interface device.

These and other features, aspects and advantages of the present invention will become better understood with reference to the following drawings, description and claims.

### BRIEF DESCRIPTION OF THE DRAWINGS

FIG. 1 is an oblique perspective view of a therapeutic mouse shown in use;

FIG. 2 is a an oblique perspective view of the therapeutic mouse of FIG. 1 with a flexible cover shown as a dashed line;

FIG. 3 is a cross sectional view of the therapeutic mouse of FIG. 1 taken along line 3-3 shown in a first configuration with an operator's hand shown as a dashed line;

FIG. 4 is a cross sectional view of the therapeutic mouse of FIG. 1 taken along line 3-3 shown in a second configuration;

FIG. 5 is a cross sectional view of the therapeutic mouse of FIG. 1 taken along line 5-5 shown in a third configuration with an operator's hand shown as a dashed line;

FIG. 6 is a cross sectional view of the therapeutic mouse of FIG. 1 taken along line 5-5 shown in a fourth configuration;

FIG. 7 is a cross sectional view of the therapeutic mouse of FIG. 1 taken along line 5-5 shown in a fifth configuration;

FIG. 8 is an exploded view of the therapeutic mouse of FIG. 1; and

FIG. 9 is a process flow diagram of a method of controlling the therapeutic mouse of FIG. 1.

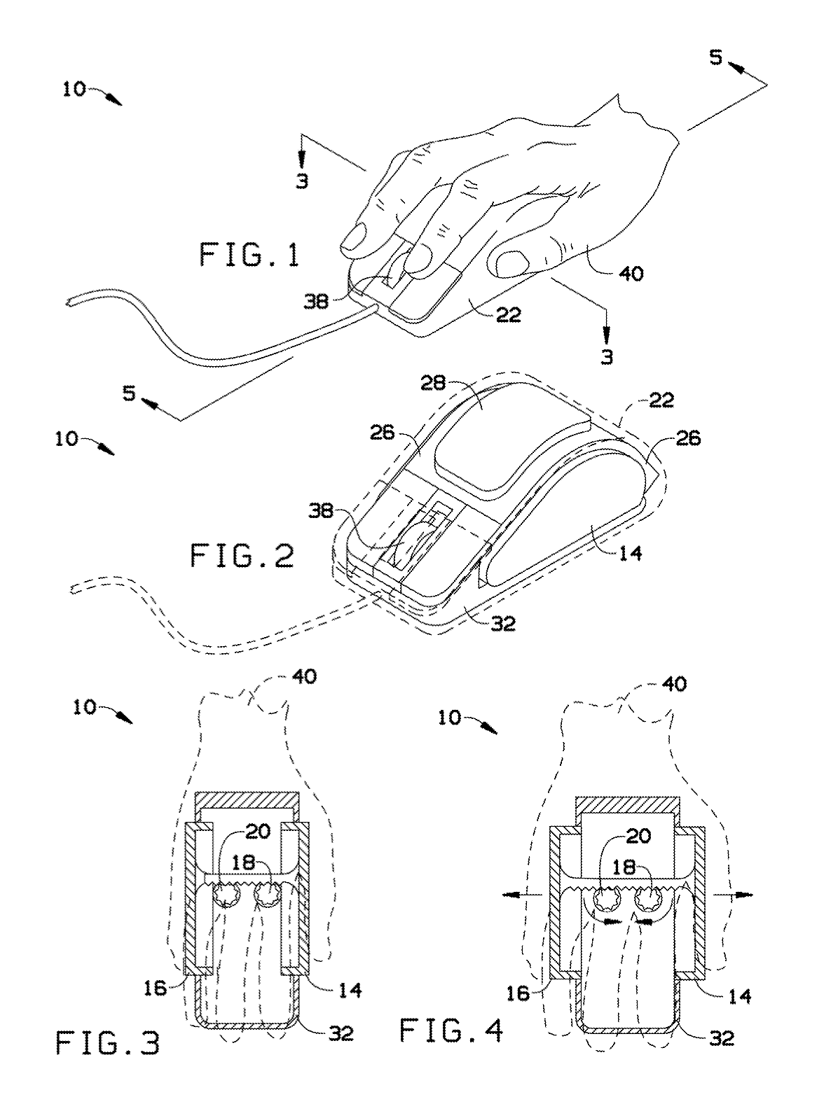

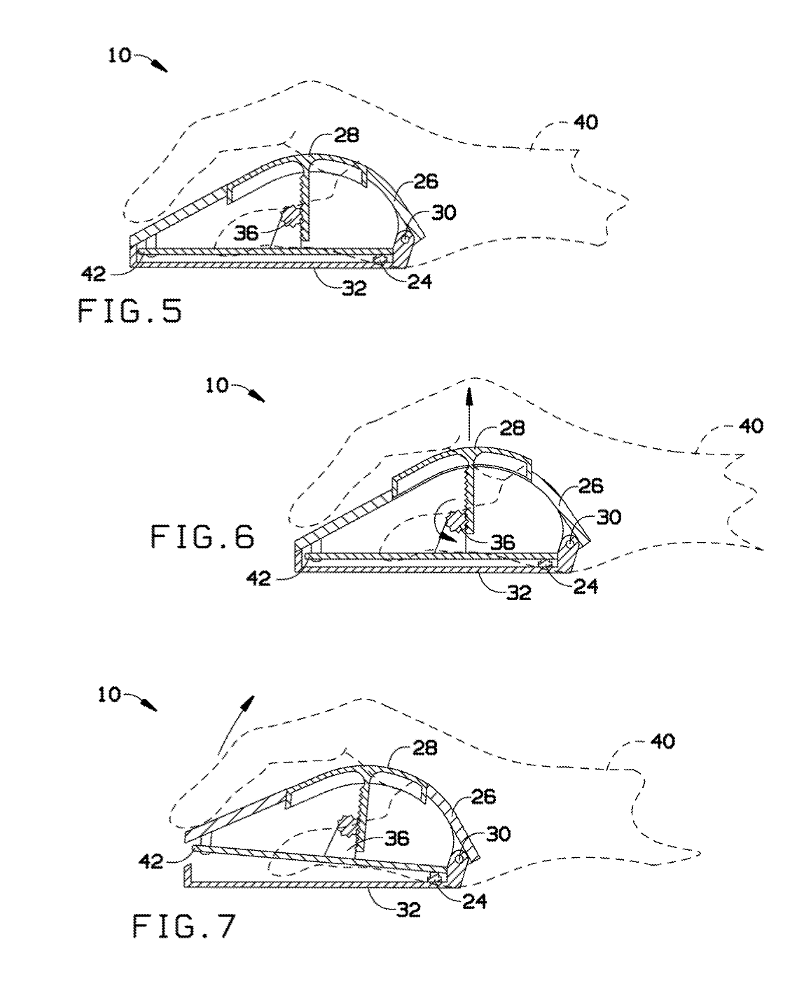

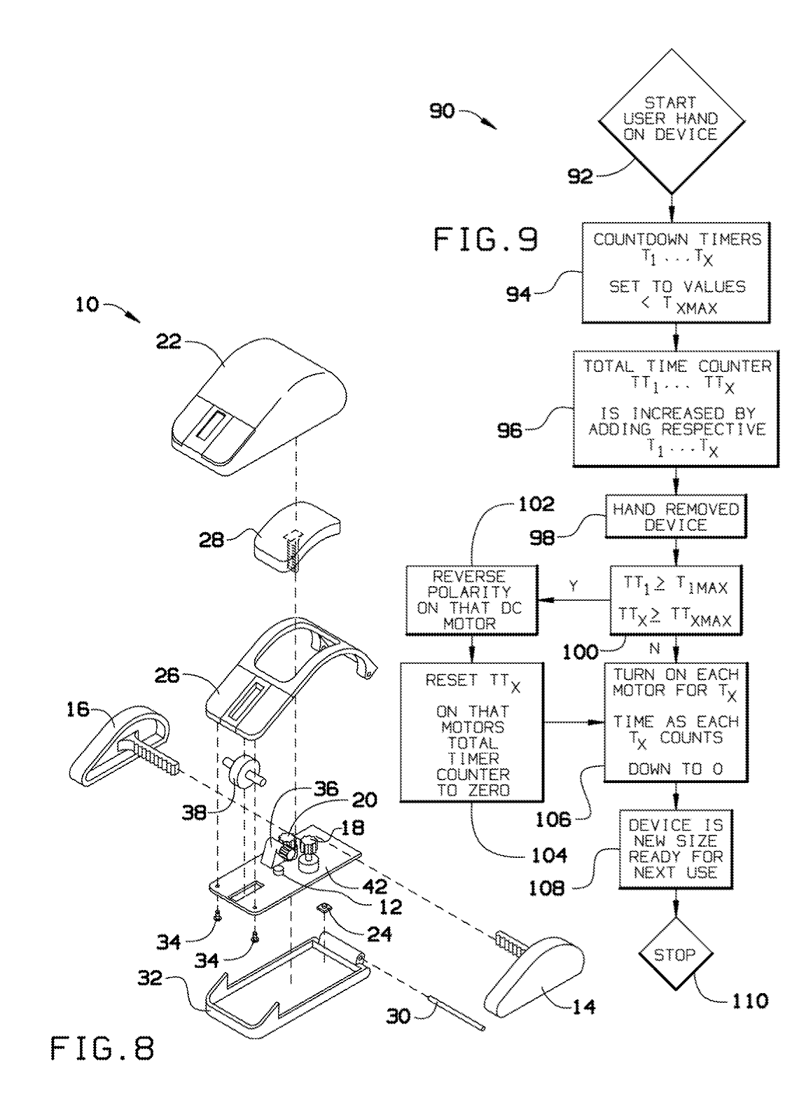

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention, since the scope of the invention is best defined by the appended claims.

Various inventive features are described below that can each be used independently of one another or in combination with other features.

Broadly, embodiments of the present invention generally provide a therapeutic human interface device that changes size and shape intermittently during use. The changing size and shape prevent repetitive motion disorders that may cause nerve irritation and micro muscle fatigue by reducing a chance of repeated use injuries such as tendinitis and carpal tunnel injuries.

Referring to the Figures, a therapeutic mouse 10 is shown that may be manipulated by a user 40 on a surface or in three-dimensional space. User 40 may grasp therapeutic mouse 10 by a flexible cover 22 and manipulate a scroll wheel 38. Therapeutic mouse 10 may include an input device subassembly 12 that may be situated on a circuit board 42 and may provide relative positional and orientation feedback to therapeutic mouse 10.

A left side wall 14 may be in mechanical communication with a left side wall drive subassembly 18, which may be situated on circuit board 42. A right side wall 16 may be in mechanical communication with a right side wall drive subassembly 20, which may be situated on circuit board 42. A top wall 28 may be in mechanical communication with a top wall drive subassembly 36, which may be situated on circuit board 42.

One or more fasteners 34 may secure a movable wall 26 to circuit board 42. A hinge rod 30 may assemble movable wall 26 on one end thereof to a lower cover 32, and may provide rotatable movement for movable wall 26 and allow circuit board to nest inside lower cover 32. A switch 24 may be situated on a bottom side of circuit board 42, and may be a momentary switch to detect a tilt or rotation thereof.

Left side wall, right side wall, and top wall drive subassemblies 18, 20, 36 may include mechanical actuators that may include a gear or toothed member for engaging a track, idle gear, or belt, for example, that may be in mechanical communication with a track, shaft, or surface for example, of left side, right side, and top walls 14, 16, 28 respectively, which may be moved or urged thereby in a reciprocating motion in a plane about parallel with the track, shaft, or surface.

Portions of left side, right side, and top walls 14, 16, 28 may be disposed on an outside surface of therapeutic mouse 10, and may be configured to press against an inside surface of flexible cover 22, causing flexible cover 22 to deform, and therefore, alter a dimensional quality of therapeutic mouse 10.

According to some other exemplary embodiments, left side wall, right side wall, and top wall drive subassemblies 18, 20, 36 may be means for urging or moving left side, right side, and top walls 14, 16, 28, and may include a drive gear in mechanical communication to the wall by a transmitting means such as a connecting rod or a track, for example, to reciprocate the wall by a rotation of the drive gear, which may be in communication with a motor that may include a stepper motor, for example.

Input device subassembly 12 may include an encoded track ball, optical or laser input module, and standard input device buttons. Input device subassembly 12 may interface with a computing device through electronic communication (e.g., PS/2, universal serial bus (USB)), or radio communication. Lower cover 32 may be a rigid element that may include a metal (e.g., aluminum or stainless steel) or plastic (e.g., acrylonitrile butadiene styrene (ABS), polycarbonate, nylon), and may provide structural support for therapeutic mouse 10.

A method of controlling therapeutic mouse 10 may include steps implemented by elements described herein. According to one exemplary embodiment, circuit board 42 may include a logic device or hardware that may include instructions embedded thereon that execute one or more steps of the method. Circuit board 42 may include a plurality of electrical components that may provide control, transmission, and buffering, for example. According to other exemplary embodiments, circuit board 42 may receive, interpret, and execute control instructions implemented by software operating on the computing device that may be in communication with therapeutic mouse 10. Circuit board 42 and the software operating on the computing device may be referred to herein as a controller.

Referring now to FIG. 9, a method 90 of controlling therapeutic mouse 10 may include determining, by the controller, that therapeutic mouse 10 is engaged by user 40, step 92. The controller may create a plurality of countdown timer values T₁ through T_{X} and may correspondingly set values thereof to values that are less than a preset or predetermined value T_{XMAX}, step 94. The controller may create a plurality of total time counters TT₁ through TT_{X} and may increase values thereof by adding countdown timer values T₁ through T_{X} respectively thereto. The controller may associate each of the plurality of total time counters TT_{N} (for TT₁ through TT_{X}) and countdown timer values T_{N} (for T₁ through T_{X}) to a drive subassembly (e.g., left side wall, right side wall, top wall drive subassemblies 18, 20, 36). The controller may determine that therapeutic mouse 10 is not engaged (e.g., device is not in use) by user 40, step 98. The controller may determine whether total time counter TT_{N} is greater than or equal to a corresponding countdown timer value T_{N}, step 100. If the total time value TT_{N} is greater than the corresponding countdown timer value T_{N}, the controller may reverse a polarity of the corresponding drive subassembly, step 102. The controller may reset the total time value TT_{N} to zero, step 104. If the total time value TT_{N} is not greater than a corresponding countdown timer value T_{N}, the controller may activate or engage the corresponding drive subassembly for a time equivalent to the corresponding countdown timer value T_{N}, step 106. The controller may determine that it has completed activating or engaging the corresponding drive subassemblies, and may determine that therapeutic mouse 10 is ready for a next use by user 40, step 108. The controller may idle in a sleep or polling state, step 110.

According to another exemplary embodiment, the method of controlling therapeutic mouse 10 may include determining, by the controller, that therapeutic mouse 10 is engaged by user 40. The controller may wait for a period of time, which may be a predetermined, configurable (e.g., user settable) period of time, or randomly determined period of time. Waiting may include instructions for sleeping or polling. The controller may activate a drive subassembly to engage or move a respective movable wall, which may be moved or urged a distance or magnitude. The controller may wait for a second period of time, which may be a predetermined, configurable, or randomly determined period of time, and the controller may then activate a second drive subassembly to engage or move a respective second movable wall, which may be moved or urged a second distance or magnitude.

The controller may determine that therapeutic mouse 10 is not engaged by user 40. The controller may wait for a third period of time, which may be a predetermined or configurable period of time, which may indicate an idle or inactive state, and the controller may return therapeutic mouse 10 to an initial configuration, which may include a neutral or preset configuration.

According to some exemplary embodiments, circuit board 42 may include a tilt drive subassembly (not pictured) that may be in mechanical communication with a cam or gear drive that may control a tilt of circuit board 42 with respect to lower cover 32 of up to about thirty degrees above or below a horizontal plane about a horizontal axis of therapeutic mouse 10. Left side, right side, and top walls 14, 16, 28 and movable wall 26 may be ridged, molded plastic (e.g., ABS, polycarbonate) and may be configured to extend about 0.01 to about 0.6 inch beyond an outside surface of movable wall 26. Left side wall, right side wall, and top wall drive subassemblies 18, 20, 36 may be stepper motors, for example. Flexible cover 22 may be an injection molded polyurethane (PU) or silicone that may exhibit elastic and may be about 0.01 to about 0.15 inch thick.

According to other exemplary embodiments, therapeutic mouse 10 may be configured to tilt side-to-side up to about thirty degrees from horizontal to either side about a vertical axis of therapeutic mouse 10.

It should be understood, of course, that the foregoing relates to exemplary embodiments of the invention and that modifications may be made without departing from the spirit and scope of the invention as set forth in the following claims.

What is claimed is:

1. A therapeutic human interface device, comprising:
an input device subassembly for detecting a movement of the therapeutic human interface device;
a movable section disposed on the therapeutic human interface device, wherein the movable section is configured to move to alter a dimensional quality of the therapeutic human interface device;
a drive system subassembly for causing the movable section to move; and
a controller in communication with the drive system subassembly and the input device subassembly.

2. The therapeutic human interface device of claim 1, further comprising:
a second movable section disposed on the therapeutic human interface device, wherein the second movable section is configured to move to alter a second dimensional quality of the therapeutic human interface device, wherein the drive system subassembly causes the second movable section to move, and
wherein the first and the second dimensional qualities are chosen from a group consisting of width, height, length, camber, and caster.

3. The therapeutic human interface device of claim 1, further comprising:
a second movable section disposed on the therapeutic human interface device, wherein the second movable section is configured to move to alter a second dimensional quality of the therapeutic human interface device; and
a second drive system subassembly for causing the second movable section to alter a second dimensional quality of the therapeutic human interface device, wherein the controller is in communication with the second drive system subassembly,
wherein the movement of the therapeutic human interface device is over a surface or in three-dimensional space.

4. The therapeutic human interface device of claim 3, further comprising:
a third movable section disposed on the therapeutic human interface device, wherein the third movable section is configured to move to alter a third dimensional quality of the therapeutic human interface device; and
a third drive system subassembly for causing the third movable section to move, wherein the controller is in communication with the third drive system subassembly, and wherein the dimensional quality, the second dimensional quality, and the third dimensional quality are different.

5. The therapeutic human interface device of claim 3, wherein the dimensional quality and the second dimensional quality are different.

6. The therapeutic human interface device of claim 3, further comprising a switch for detecting a user engaging the therapeutic human interface device.

7. The therapeutic human interface device of claim 6, wherein the switch detects a tilt of the therapeutic human interface device relative to the surface.

8. A pointing device for detecting two-dimensional motion relative to a surface, the pointing device comprising:
a controlling circuit;
a movable side wall having a first surface disposed on an outside surface of the pointing device;
a movable top wall having a second surface disposed on the outside surface of the pointing device;
a first means for urging the movable side wall in a first direction, wherein the first means for urging is controlled by the controlling circuit; and
a second means for urging the movable top wall in a second direction, wherein the second means for urging is controlled by the controlling circuit.

9. The pointing device of claim 8, further comprising:
a flexible cover disposed on an outside surface of the pointing device.

10. The pointing device of claim 8, further comprising:
a second movable side wall having a third surface disposed on the outside surface of the pointing device; and
a third means for urging the second movable side wall in a third direction,
wherein the third means for urging is controlled by the controlling circuit.

11. The pointing device of claim 8, further comprising:
means for sensing a usage of the pointing device.

12. A method of controlling a dimensional quality of a human interface device, comprising:
determining that the human interface device is engaged by a user;
setting a countdown timer;
setting a total time counter;
incrementing the total time counter;
determining that the human interface device is not engaged by the user;
determining that the total time counter is not less than or equal to the countdown timer; and
activating a drive subassembly associated to the countdown timer, wherein the drive subassembly alters the dimensional quality of the human interface device.

13. The method of claim 12, further comprising:
associating the drive subassembly to the countdown timer;
determining that the total time counter is less than or equal to the countdown timer; and
reversing a polarity of the drive subassembly.

14. The method of claim 13, further comprising resetting the total time counter to zero, wherein the activating the drive subassembly is for a length of time equal to the countdown timer.

15. The method of claim 14, further comprising:
setting a second countdown timer;
setting a second total time counter;
incrementing the second total time counter;
associating a second drive subassembly to the second countdown timer;
determining whether the second total time counter is not less than or equal to the second countdown timer;
reversing a polarity of the second drive subassembly; and
activating the second drive subassembly, wherein the second drive subassembly alters a second dimensional quality of the human interface device.
